(19) United States
(12) Patent Application Publication
(10) Pub. No.: US 2009/0229097 A1
(43) Pub. Date: Sep. 17, 2009

(54) Human and animal cremated ashes automated spreading device

(76) Inventor: Scott H. Crandlemire, Meridian, ID (US)

Correspondence Address: Scott H. Crandlemire, 3810 W. Park Creek Dr., Meridian, ID, 83642, US

(21) Appl. No.: 12/218,331

(22) Filed: Jul. 14, 2008

Related U.S. Application Data
(60) Provisional application No. 61/011,621, filed on Mar. 11, 2008.

(51) Int. Cl. A61G 17/00

(52) U.S. Cl. 27/1

(57) ABSTRACT

The “RELEASE URN” (commercial product name) is a mechanical device designed specifically to temporarily store, and then aid in the spreading of both human and animal cremated remains (ashes). The device consists of a hopper, where the ashes are loaded, a valve to release the ashes into the ash chute, a low pressure venturi, a push rod/cam actuator, micro switch, battery, a blower assembly, ash port, and a decorative “box”, made of various materials including wood, pressboard, metal, plastic, plywood with wood veneer, fiberglass, or composite, that houses the mechanical parts, and hardware that, holds the “box” together, provides a handle for lifting the box, and, provides a handle to the push rod actuator.

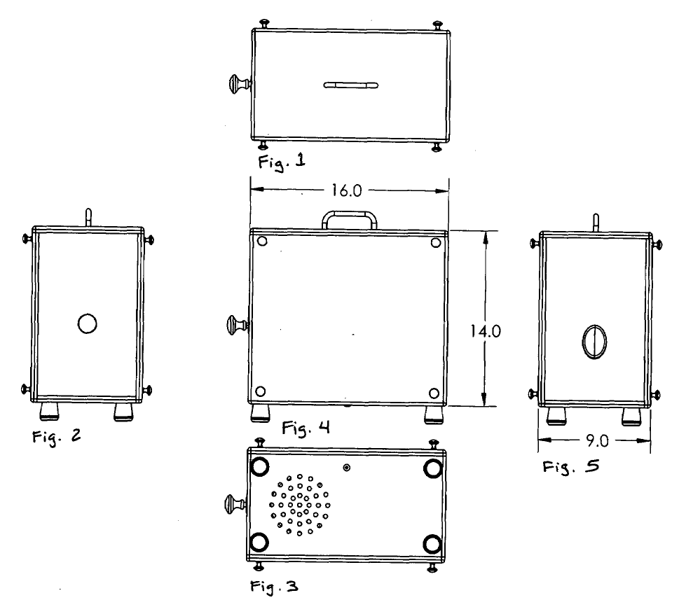

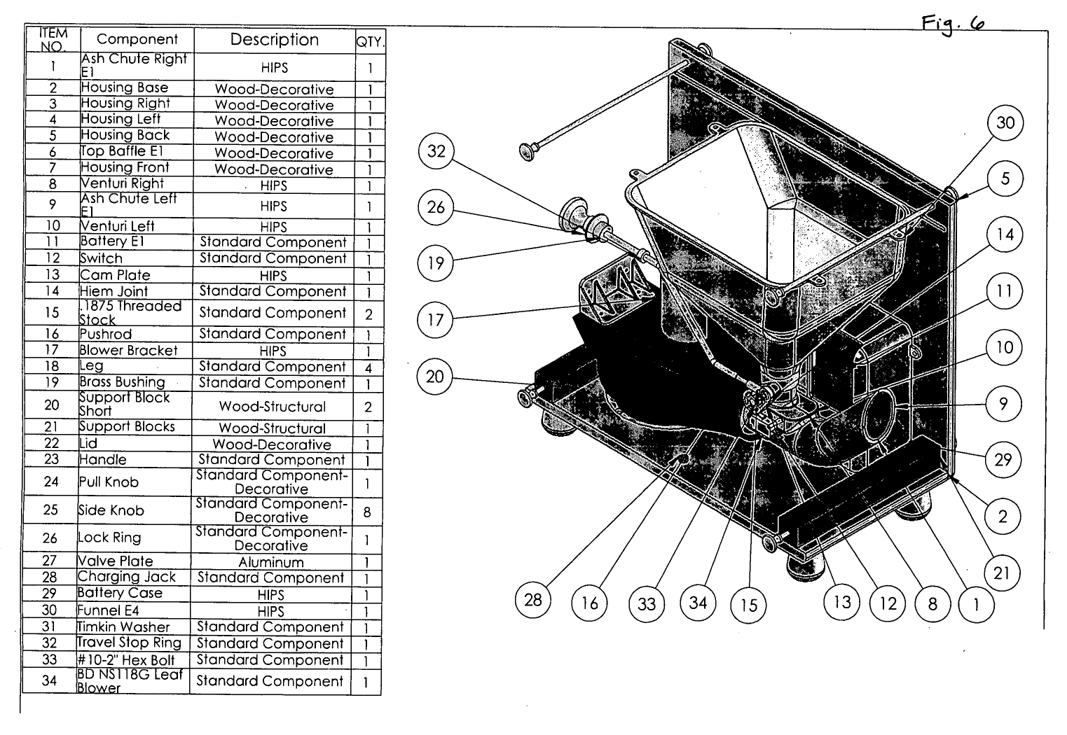

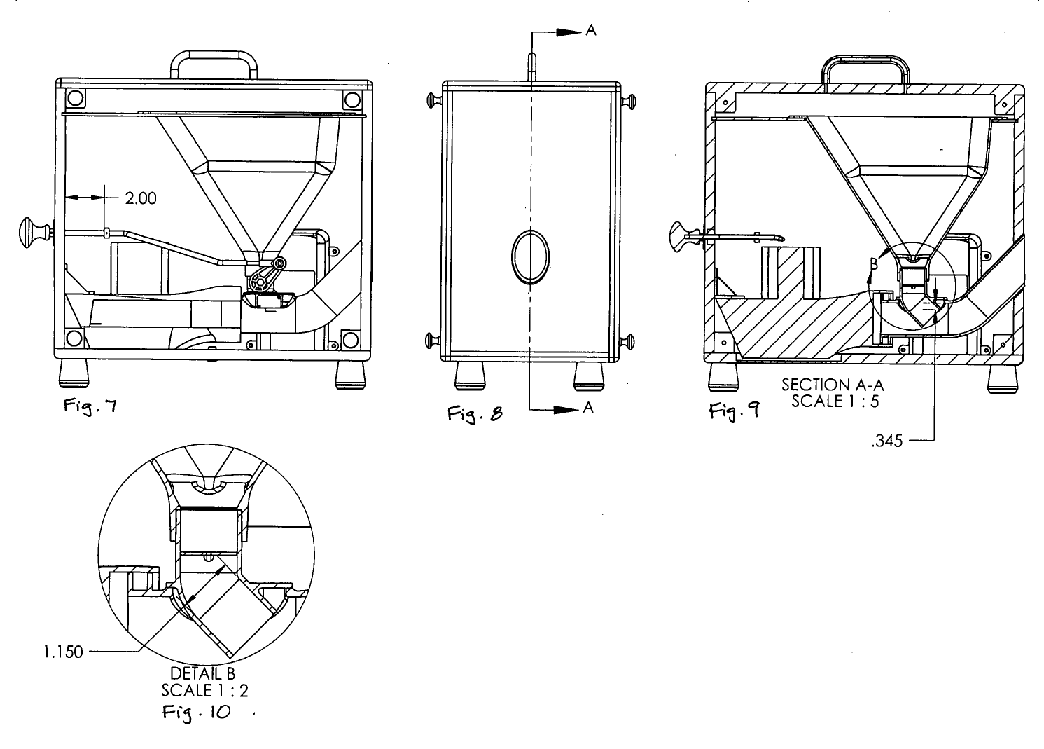

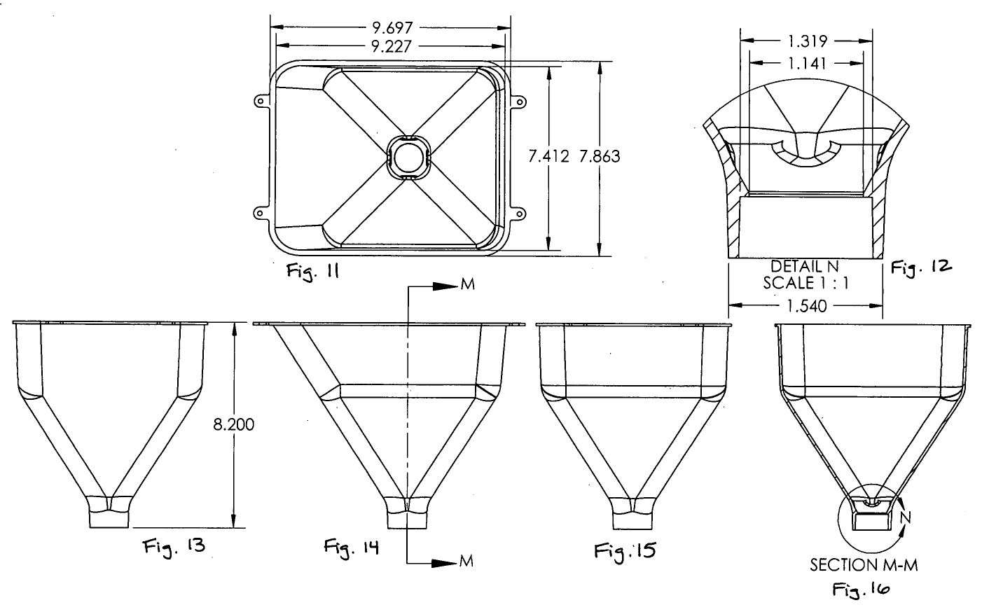

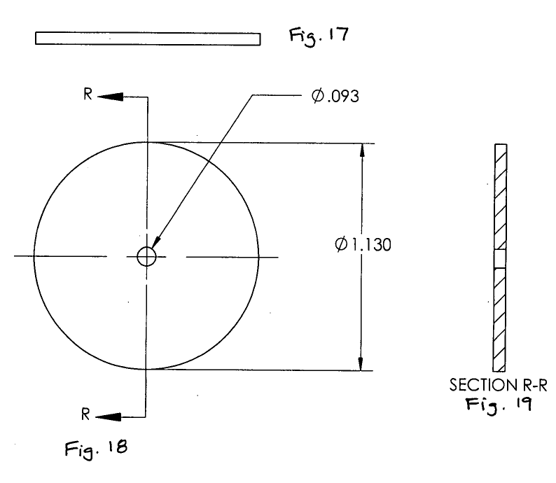

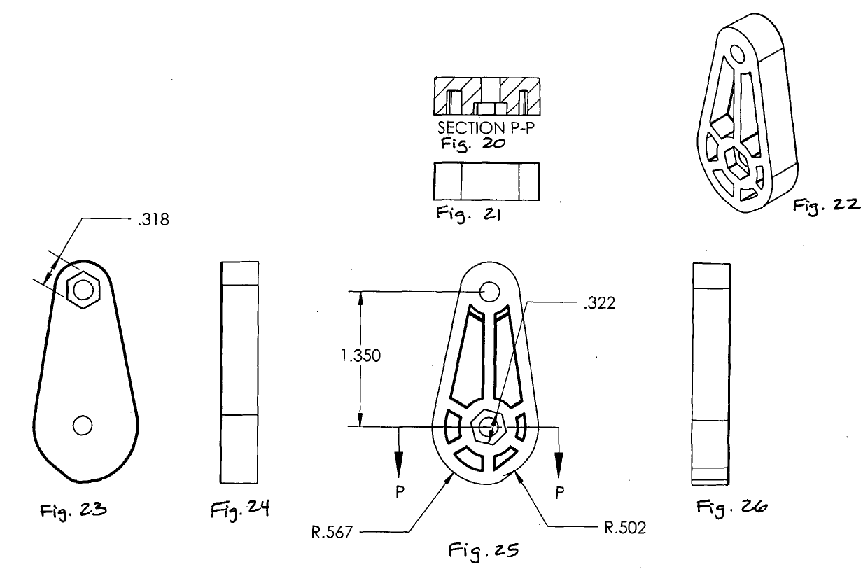

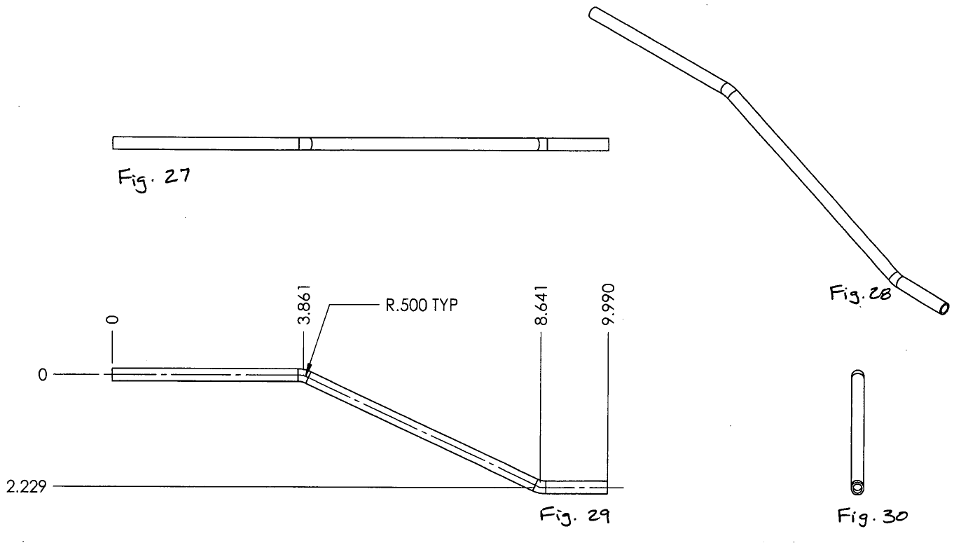

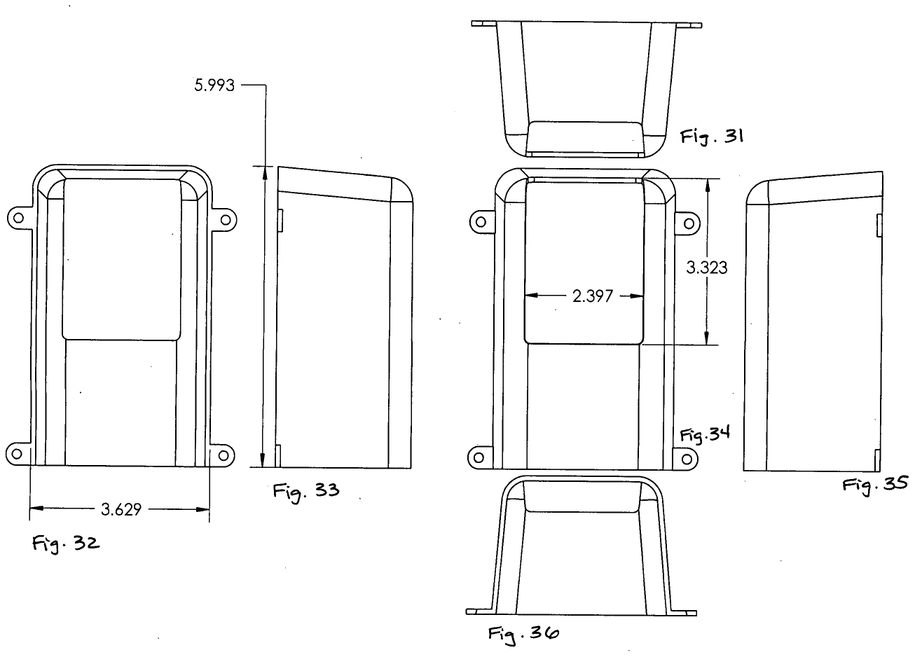

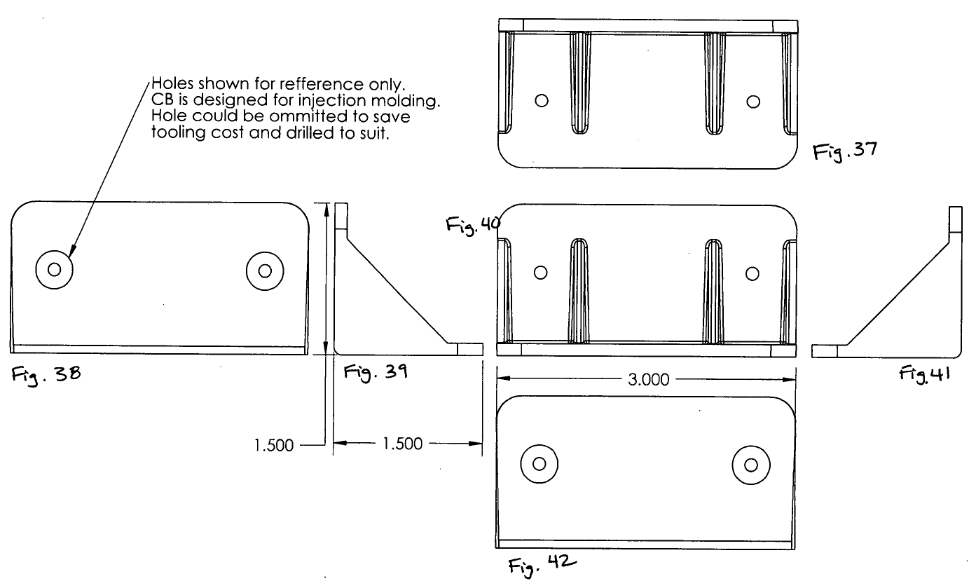

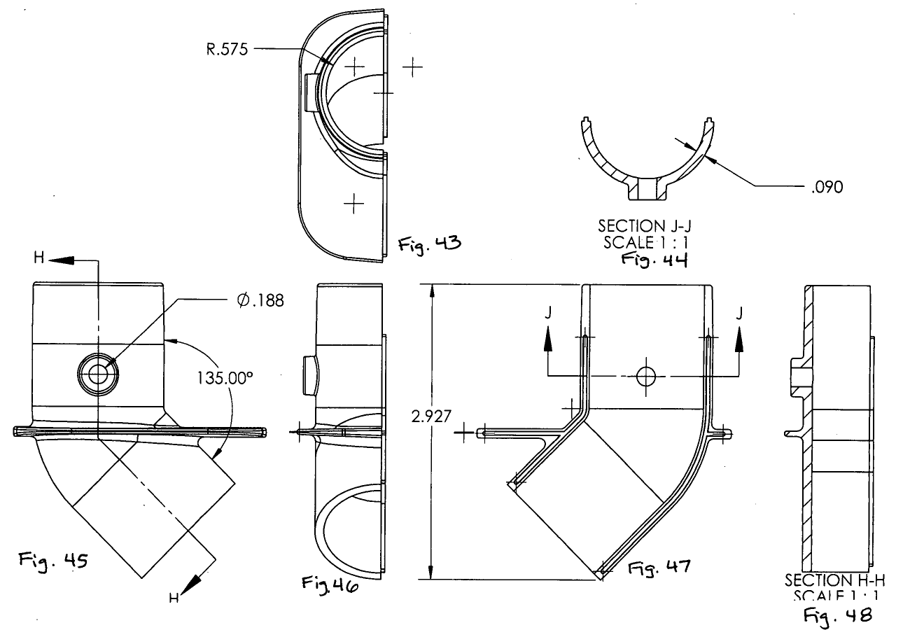

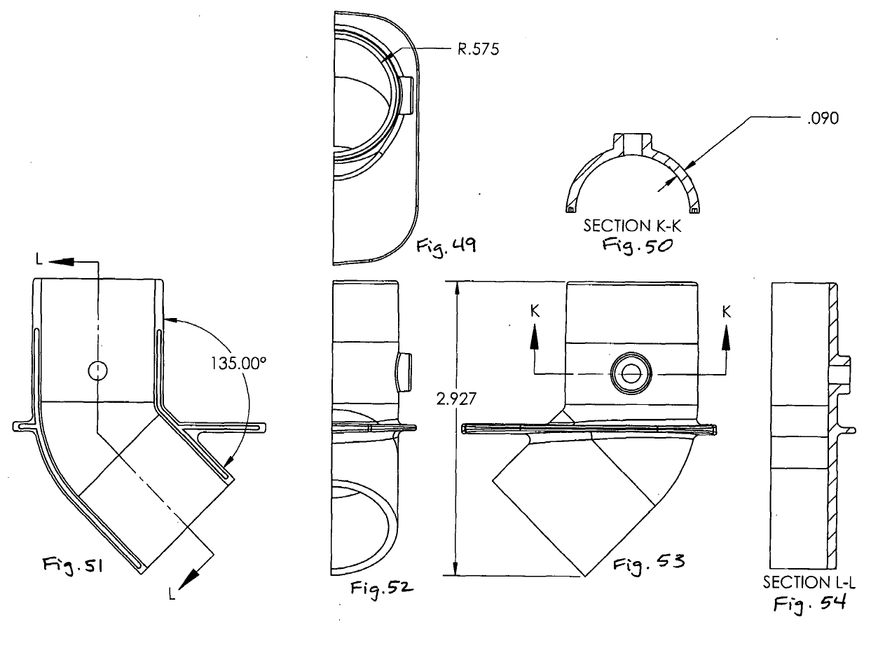

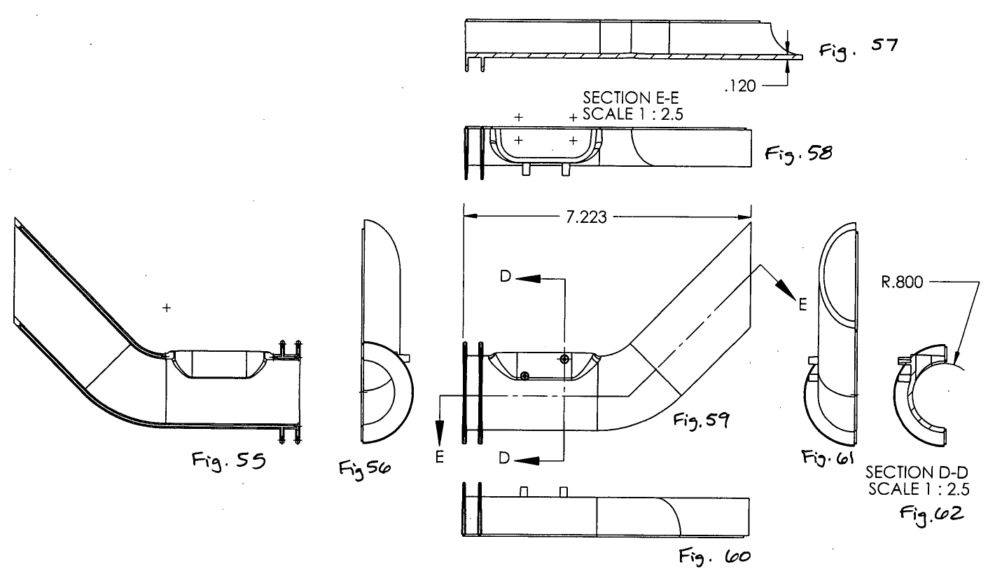

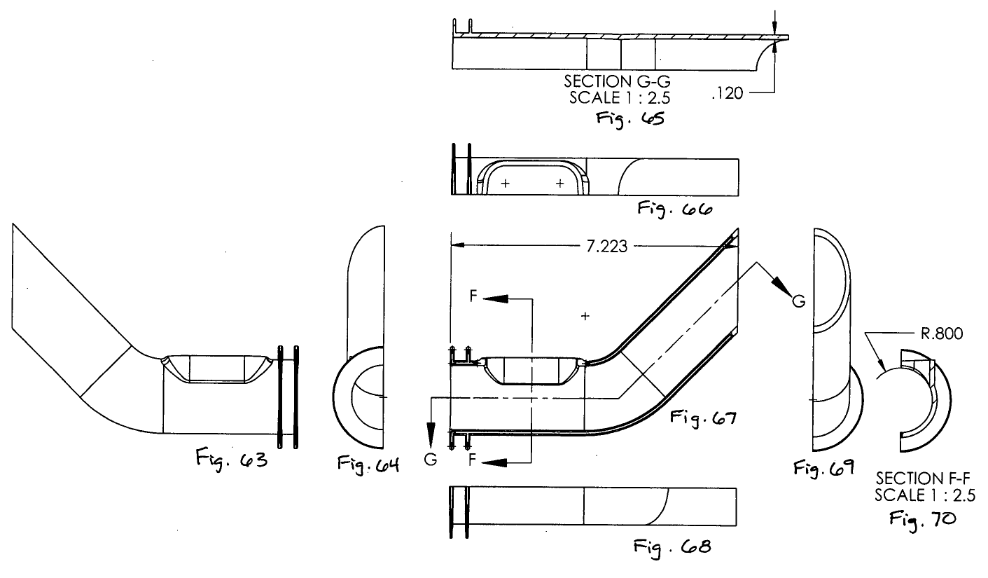

The Human and animal cremated ashes mechanical spreading device consists of . . .
1. a decorative enclosure which houses the internal workings and provides an aesthetic exterior. The dimensions of the enclosure are typically 9″ wide, 16″ long, and 14″ tall (dimensions may vary due to enclosure materials used, and or a reduction/increase in the hopper size). (see FIGS. 1-5 & FIGS. 6.20 & 6.29) It is held together by a system of decorative knobs, thru-rods, and support blocks. By removing the knobs on one side allows the thru-rods to be pulled out through the interior support blocks. Removing the upper knobs and rods allows the lid to be removed and gives access to the hopper for the loading of ashes. Removing the upper and lower knobs and rods allows a side panel to be removed to provide access to the internal mechanism. The enclosure also has a decorative/functional handle for carrying the device, as well as rubber feet, a release port where the ashes are released, and a decorative knob, which when pulled is linked to an actuator rod that engages a release valve and a micro-switch which starts the motor. The interior of the enclosure is lined with aircraft grade noise reduction foam.
2. the hopper, which is essentially a funnel shaped part containing approximately 220 cubic inches of volume (may vary for animal release urns). The hopper is sealed at the top by the lid of the enclosure, and temporarily holds the ashes via a closed butterfly valve.
3. the valve plate, which is located at the bottom of the hopper funnel, and is actuated via the cam and actuator push rod (see FIGS. 9 & 10 & FIGS. 17-19).
4. the cam plate (see FIG. 6.13 & FIGS. 221-26) which connects the push rod to the valve plate and micro-switch.
5. the micro-switch which engages the battery driven modified leaf blower.
6. the pushrod/actuator (see FIG. 6.16 & FIGS. 27-30), which is a bent tube connected through a hole in the decorative enclosure to a decorative pull knob.
7. the modified leaf blower (FIG. 6.34) which is attached to the outer enclosure with a bracket, (FIG. 6.17 & FIGS. 37-42) and provides the compressed air for the device.
8. the rechargeable battery which is a 6 VDC-24 VDC supplied with the blower unit, and supported by a case which is attached to the outer enclosure. (see FIG. 6.11 & FIGS. 31-36). The battery is recharged via a port on the underside of the enclosure.
9. the low pressure venturi (see FIGS. 6.8, 6.10 & FIGS. 43-54.) which connects the blower assembly, and ash chute.
10. and the ash chute, (see FIGS. 6.1, 6.9 & FIGS. 57-70) which connects the hopper and venturi (the area where the ashes and compressed air meet), and passes through the outer enclosure where the ashes are released.
To use the device, one removes the top of the enclosure and loads the ashes into the hopper. The lid is then replaced. The entire device is then taken to a location for release. Placing the device with the wind direction blowing in the same direction as the ash port, a safety cotter pin is removed and the actuator handle is pulled. When the ashes are completely released, the actuator handle is pushed back in and the safety pin replaced.

### FIGURE LEGEND

1. Outer enclosure top view

2. Outer enclosure rear elevation

3. Outer enclosure bottom view

4. Outer enclosure right elevation (left similar)

5. Outer enclosure front elevation

6. Isometric (see item legend for labeled parts)

7. Interior elevation

8. Front elevation showing section cut A-A

9. Section A-A

10. Detail B of valve and venturi

11. Hopper Funnel top view

12. Detail N of valve at bottom of hopper

13. Hopper Funnel rear elevation

14. Hopper Funnel left elevation showing section cut M-M

15. Hopper Funnel front elevation

16. Hopper Funnel section M-M

17. Valve plate elevation

18. Valve plate plan view showing section cut R-R

19. Valve plate section R-R

20. Cam Plate section P-P

21. Cam Plate rear elevation

22. Cam Plate isometric

23. Cam Plate nut detail

24. Cam Plate right elevation

25. Cam Plate plan view

26. Cam Plate left elevation

27. Pushrod top view

28. Pushrod isometric

29. Pushrod right elevation

30. Pushrod rear elevation

31. Battery Case rear elevation

32. Battery Case bottom view

33. Battery Case left elevation

34. Battery Case plan view

35. Battery Case right elevation

36. Battery Case front elevation

37. Blower Bracket top view

38. Blower Bracket rear elevation

39. Blower Bracket right elevation

40. Blower Bracket front elevation

41. Blower Bracket left elevation

42. Blower Bracket bottom view

43. Venturi right top view

44. Venturi right section J-J

45. Venturi right elevation showing section cut H-H

46. Venturi right rear elevation

47. Venturi right interior elevation showing section cut J-J

48. Venturi right section H-H

49. Venturi left top view

50. Venturi left section K-K

51. Venturi left interior elevation showing section cut L-L

52. Venturi left rear elevation

53. Venturi left elevation showing section cut K-K

54. Venturi left section L-L

55. Ash Chute right interior elevation

56. Ash Chute right front elevation

57. Ash Chute right section E-E

58. Ash Chute right top view

59. Ash Chute right elevation

60. Ash Chute right bottom view

61. Ash Chute right rear elevation

62. Ash Chute right section D-D

63. Ash Chute right interior elevation

64. Ash Chute right front elevation

65. Ash Chute left section G-G

66. Ash Chute left top view

67. Ash Chute left interior elevation

68. Ash Chute left bottom view

69. Ash Chute left rear elevation

70. Ash Chute left section F-F

### SUMMARY

The “RELEASE URN” (commercial product name) is a mechanical device designed specifically to temporarily store, and then aid in the spreading of both human and animal cremated remains (ashes).

The “RELEASE URN” is the first mechanical device created for spreading ashes. It is superior to manual releases as it separates direct human contact from the release of the ashes as well as lofts the ashes into the air, as opposed to clumps of ashes falling on the ground via manual spreading, or simply falling to the ground using manual “shaker boxes”. Use of one or more “RELEASE URNS” allows multiple individual's ashes to be released and intertwined together.

1. I Scotty H. Crandlemire claim to have invented the first mechanical device created specifically to aid in the spreading of both human and animal cremated remains (ashes).
